(19) United States
(12) Patent Application Publication
(10) Pub. No.: US 2006/0285691 A1
(43) Pub. Date: Dec. 21, 2006

(54) National security alerting in wireless communication networks

(75) Inventors: Frances Mu-Fen Chin, Naperville, IL (US); Peggy H. Hasan, Aurora, IL (US); Sandra L. True, St. Charles, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/145,387

(22) Filed: Jun. 2, 2005

(51) Int. Cl. H04K 1/00

(52) U.S. Cl. 380/270

(57) ABSTRACT

A wireless communication network is described that includes a control system and a plurality of network nodes, such as MSCs. The network nodes communicate with mobile wireless devices, such as cell phones. The control system receives national security information for a geographic region. The control system identifies one or more network nodes serving the geographic region indicated in the national security information, and transmits the national security information to the identified network nodes. Each of the identified network nodes receives the national security information from the control system. The network nodes generate security alert messages based on the national security information, and transmit the security alert messages to one or more mobile wireless devices being served by that network node. In response to a security alert message, each mobile wireless device provides the security alert message, or a representation thereof, to a wireless subscriber using the mobile wireless device.

### BACKGROUND OF THE INVENTION

1. Field of the Invention

The invention is related to the field of wireless communication networks and, in particular, to systems and methods of alerting wireless subscribers of national security issues or situations in their geographic region.

2. Statement of the Problem

Cellular phones, PCS phones, and other mobile wireless devices have become very popular due to the conveniences that they provide to people. Cell phones have become compact in size, which make them easy and convenient to carry. People routinely carry their cell phones with them on their belt, in their pocket, in their purse, etc, so they are available for use at any time.

Because of the large demand for cell phone service, service providers strive to offer new services to current and potential customers. One service offered by many service providers is text messaging services, such as Short Message Service (SMS). With the text messaging service, a subscriber may send and receive messages through their cell phone. The subscriber may also sign up for services that send informational text messages to their phone, such as information on the weather, information on traffic reports, advertisements, etc. The cell phone may request the informational text messages or may automatically receive the informational text messages periodically. When the cell phone receives the text message, the cell phone may beep or otherwise indicate that a text message has arrived. The subscriber may then view the text message at his/her convenience.

In light of the terrorist attacks in the United States and around the world, people desire to be informed of national security issues. The Department of Homeland Security for the United States has implemented the Color-coded Threat Level System. The goal of the Color-coded Threat Level System is to keep people informed as to potential threats against national security. There are five threat conditions, each identified by a description and corresponding color. The color Green indicates a low threat level. The color Blue indicates a guarded threat level. The color Yellow indicates an eleveted threat level. The color Orange indicates a high threat level. The color Red indicates a severe threat level. The higher the Homeland Security threat condition, the greater the risk of a terrorist attack. Risk includes both the probability of an attack occurring and its potential gravity.

Threat conditions may be assigned for the entire nation, or they may be set for a particular geographic region or industrial sector. The threat conditions are reviewed at regular intervals, based on available intelligence, to determine whether adjustments are warranted for the Color-coded Threat Level System. Certain agencies may have preplanned sets of responses to a particular threat condition to facilitate a rapid, appropriate, and tailored response.

One problem with current cell phone service is that the service has not been effectively used to keep subscribers informed of matters of national security.

### SUMMARY OF THE SOLUTION

The invention solves the above problems and other problems by using wireless communication networks to keep people informed of matters of national security. Because of the large number of wireless subscribers, wireless communication networks may be an effective vehicle for transmitting national security information to a large number of people. By keeping people informed of matters of national security, the impact of a terrorist attack or other threat may be minimized.

In one embodiment of the invention, a wireless communication network includes a control system connected to a plurality of network nodes, such as mobile switching centers (MSC). The network nodes communicate with mobile wireless devices, such as cell phones. When in operation, the control system receives national security information for a geographic region. For instance, the national security information may comprise a status change in the Color-coded Threat Level System, may comprise information on a particular terrorist threat, or may comprise information on a particular terrorist attack having taken place. The control system identifies one or more network nodes serving the geographic region indicated in the national security information, and transmits the national security information to the identified network nodes. Each of the identified network nodes receives the national security information from the control system. The network nodes generate security alert messages based on the national security information, and transmit the security alert messages to one or more mobile wireless devices being served by that network node. In response to a security alert message, each mobile wireless device provides the security alert message, or a representation thereof, to a wireless subscriber using the mobile wireless device. The security alert message may be presented to the wireless subscriber as a voice message, a text message, a color-coded message, or any other message.

The invention may include other embodiments described below.

### DESCRIPTION OF THE DRAWINGS

The same reference number represents the same element on all drawings.

FIG. 1 illustrates a wireless communication network in an exemplary embodiment of the invention.

FIG. 2 illustrates a method of operating a wireless communication network in an exemplary embodiment of the invention.

FIG. 3 illustrates a wireless communication network in another exemplary embodiment of the invention.

FIG. 4 is a message diagram illustrating the messaging of the wireless communication network of FIG. 3.

### DETAILED DESCRIPTION OF THE INVENTION

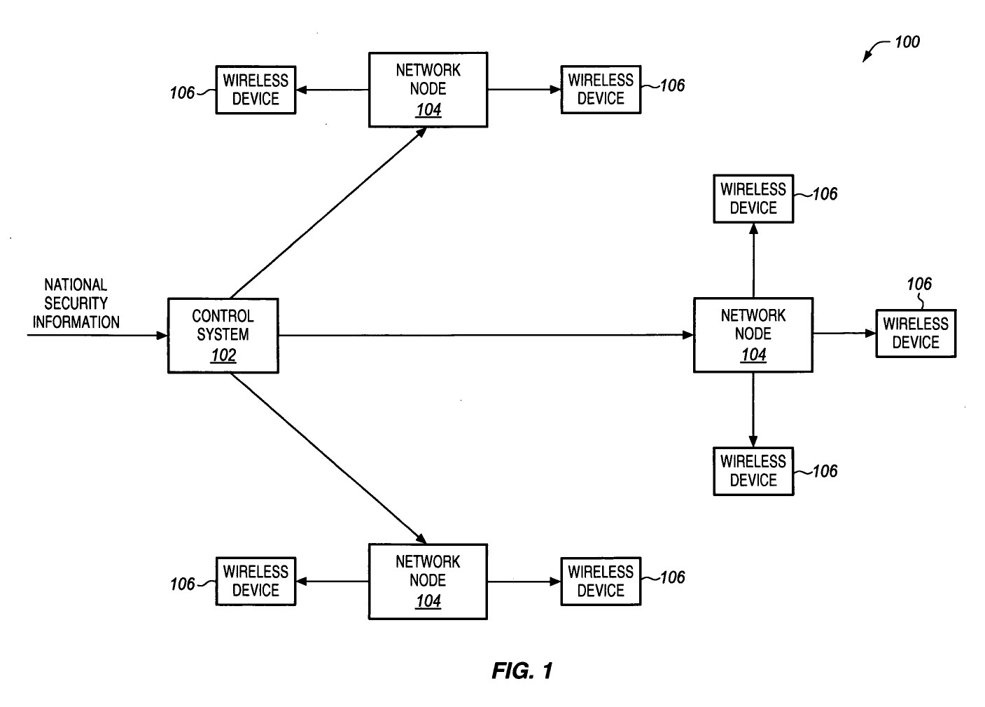

FIGS. 1-4 and the following description depict specific embodiments of the invention to teach those skilled in the art how to make and use the invention. For the purpose of teaching inventive principles, some conventional aspects of the invention have been simplified or omitted. Those skilled in the art will appreciate that variations from these embodiments may fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a wireless communication network 100 in an exemplary embodiment of the invention. Wireless communication network 100 comprises any wireless network for providing bi-directional communications of voice and/or data, such as a cellular network or a PCS network. Wireless communication network 100 is not intended to comprise a one-way broadcast-type network, such as a television network. Wireless communication network 100 includes a control system 102 connected to a plurality of network nodes 104. Network nodes 104 communicate with mobile wireless devices 106. A network node 104 comprises any system, server, or device that serves a plurality of mobile wireless devices to facilitate wireless communication. One example of a network node 104 is a mobile switching center (MSC). Mobile wireless devices 106 comprise any devices or systems configured to provide bi-directional communication via wireless signals, such as a cell phone or a PDA. Wireless communication network 100 may include other devices, systems, or components not shown in FIG. 1.

Although network nodes 104 are shown as communicating with mobile wireless devices 106, there may be intermediate equipment between network nodes 104 and mobile wireless devices 106. For instance, if network node 104 comprises an MSC, then there may be a plurality of base stations (not shown) between the MSC and the mobile wireless devices 106. Each base station may communicate with mobile wireless devices 106 using Code Division Multiple Access (CDMA), Time Division Multiple Access (TDMA), Global System for Mobile Communication (GSM), Universal Mobile Telecommunications System (UMTS), or another protocol.

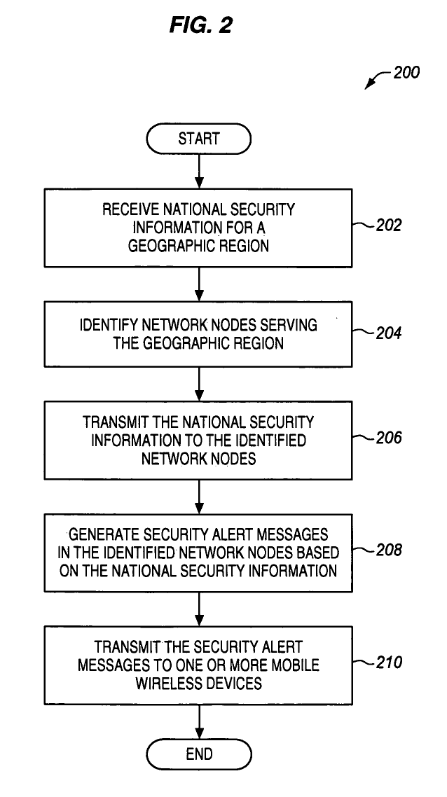

FIG. 2 illustrates a method of operating wireless communication network 100 in an exemplary embodiment of the invention. To begin in step 202, control system 102 receives national security information for a geographic region. National security information comprises any information or data relevant to the security of a nation. For instance, the national security information may comprise a status change in the Color-coded Threat Level System, may comprise information on a particular terrorist threat, or may comprise information on a particular terrorist attack having taken place. Control system 102 may receive the national security information from any system capable of producing such information, such as a system maintained by a government organization or another organization or agency.

In step 204, control system 102 identifies one or more network nodes 104 serving the geographic region indicated in the national security information. Control system 102 transmits the national security information to the identified network nodes 104.

Each of the identified network nodes 104 receives the national security information from control system 102 and operates as follows. The network nodes 104 generate security alert messages based on the national security information in step 206. A security alert message comprises any signal, bit sequence, instruction, or other data that conveys all or a portion of the national security information to a subscriber. The security alert messages may indicate a status change in the Color-coded Threat Level System for the geographic region, may indicate a particular terrorist threat for the geographic region, may indicate a particular terrorist attack having taken place in the geographic region, etc.

The network nodes 104 transmit the security alert messages to one or more mobile wireless devices 106 being served by that network node 104 in step 208. In one embodiment, the network nodes 104 may transmit the security alert messages to mobile wireless devices 106 that have subscribed to a special service, such as a national security alerting service. In another embodiment, the network nodes 104 may broadcast the security alert messages to all mobile wireless devices 106 being served by that network node 104.

In response to a security alert message, each mobile wireless device 106 provides the security alert message, or a representation thereof, to a wireless subscriber using the mobile wireless device 106. The security alert message may be presented to the wireless subscriber as a voice message, a text message, a color-coded message, or any other message. The security alert message may be unique to national security situations to ensure that the wireless subscriber pays attention when the security alert message is provided.

Wireless communication network 100 is advantageously operable to alert wireless subscribers of national security issues. For instance, if the Department of Homeland Security raises the threat level for the Color-coded Threat Level System from “elevated” to “high” for a particular geographic region, then wireless subscribers in that geographic region may be alerted via their mobile wireless device. Wireless communication network 100 may get the security alert messages to more people to help reduce the impact of a terrorist attack or another national security situation.

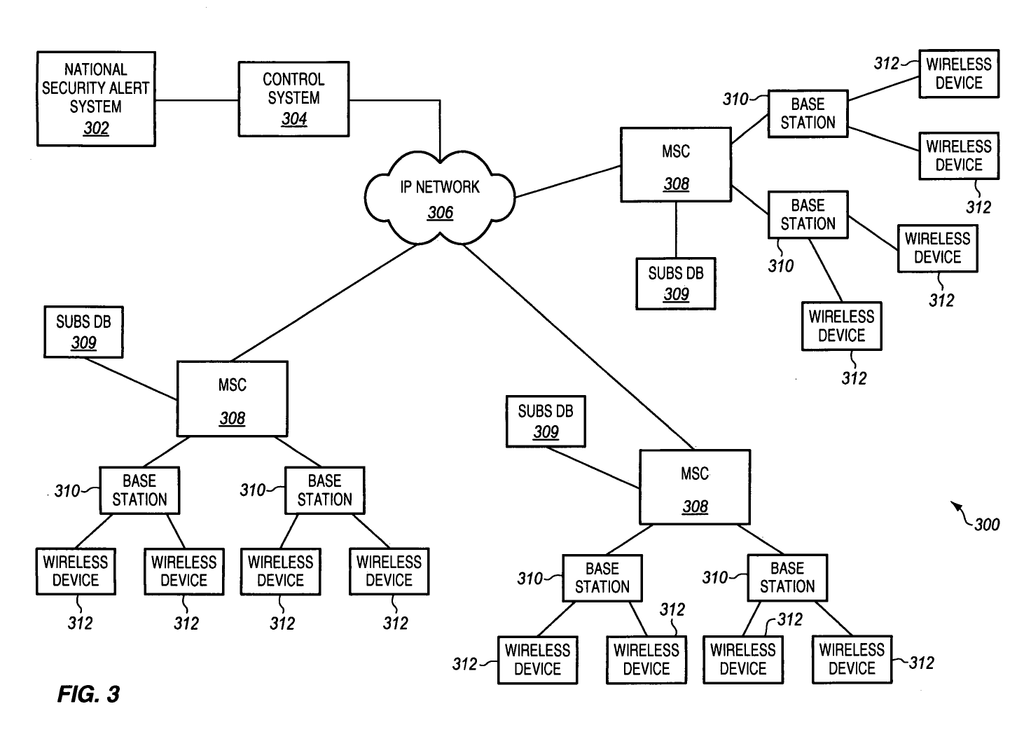

FIG. 3 illustrates a wireless communication network 300 in another exemplary embodiment of the invention. Wireless communication network 300 includes a national security alerting control system 304, an IP network 306, a plurality of MSCs 308, a plurality of subscriber databases 309, and a plurality of base stations 310. Control system 304 is coupled to a national security alert system 302. National security alert system 302 comprises any system, server, entity, agency, etc, that monitors information relating to national security. National security alert system 302 may be a governmental organization, such as the Department of Homeland Security, or some other public or private organization. Control system 304 is also coupled to the IP network 306 in order to communicate with MSCs 308. Although three MSCs 308 are shown in FIG. 3, wireless communication network 300 may comprise many more MSCs. Each MSC 308 is coupled to a plurality of base stations 310 as is known in the art. Some conventional components of wireless communication network 300 are not shown in FIG. 3 for the sake of brevity, but are still within the scope of the invention.

The base stations 310 are configured to communicate with a plurality of mobile wireless devices 312 within their service area. Each base station 310 creates a “cell” that represents a service area for the base station. The base stations 310 communicate with the mobile wireless devices 312 using CDMA, TDMA, GSM, UMTS, or another protocol. Mobile wireless devices 312 within the service area of a base station 310 are able to communicate with the base station 310. Each mobile wireless device 312 is being operated by a wireless subscriber (not shown) that subscribes to the wireless service of a wireless service provider, such as Verizon, Cingular, etc.

One or more of the wireless subscribers additionally subscribe to a national security alerting service offered by the wireless service provider. For those subscribers additionally subscribing to the national security alerting service, the wireless service provider updates their subscriber record in their subscriber database 309 to indicate their additional subscription. The subscriber database 309 may comprise a Home Location Register (HLR) and/or a Visiting Location Register (VLR). The wireless subscriber may also define their preferred method of receiving security alert messages. For instance, one method of receiving security alert messages may be receiving voice messages. Another method may be receiving text, data, or picture messages. Another method may be receiving some type of message that causes the mobile wireless device to display a color-coded message similar to the color codes of the Color-coded Threat Level System.

When in operation, national security alert system 302 transmits national security information to control system 304. The national security information is for a geographic region of the nation. The geographic region may be for the whole nation, individual states in the nation, individual areas within a state, or any other geographic region. For instance, the national security information may comprise a raise in the alert status of the Color-coded Threat Level System for the entire nation, a raise in the alert status for a particular city, a raise in the alert status for the financial district of New York City, etc.

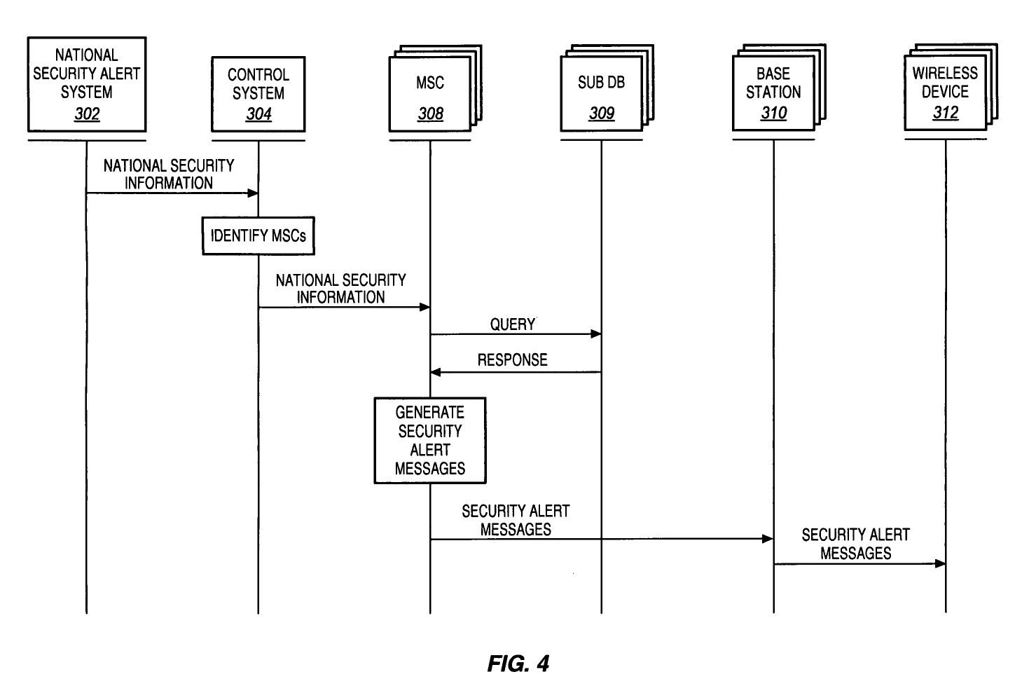

FIG. 4 is a message diagram illustrating the messaging of the wireless communication network 300 of FIG. 3. Control system 304 receives the national security information from national security alert system 302 for a geographic region. The national security information may include GPS coordinates for the geographic region. Alternatively, control system 304 may determine the GPS coordinates from the information on the geographic region. Control system 304 then compares the GPS coordinates for the geographic region with the service areas of the MSCs 308 in the network 300 to identify one or more of the MSCs 308 serving the affected geographic region. Control system 304 transmits the national security information to the identified MSCs 308.

Each MSC 308 then operates as follows responsive to receiving the national security information. The MSCs 308 determine which mobile wireless devices 312 being served by that MSC subscribe to the national security alerting service. The MSCs 308 query their subscriber databases 309, which include an HLR and a VLR, for subscribers to the national security alerting service that are in the service area of an MSC 308. The subscriber databases 309 identify which subscribers are in the service area, and transmit response messages back to the MSCs 308 indicating the subscribers.

By querying the subscriber database 309, the MSCs 308 can identify the subscribers in their service area. If a subscriber is roaming out of the region affected by a national security situation, then that subscriber would not be contacted by an MSC 308. Also, if a subscriber having a home area outside of affected region has roamed into the affected region, then an MSC 308 would contact that subscriber.

The query from the MSCs 308 to the subscriber databases 309 may also include a request for a preferred method of receiving security alert messages. The subscriber databases 309 identify the preferred method for each subscriber, and include the preferred method of receiving security alert messages in the response messages to the MSCs 308.

The MSCs 308 then generate security alert messages based on the national security information received from control system 304. The security alert messages may depend on the preferred method of receiving a security alert message for each subscriber. For instance, one subscriber may request a text message, while another subscriber may request a voice message. The MSCs 308 generate the security alert messages in the appropriate format and transmit the security alert messages to the mobile wireless device 312 of each subscriber in its area through the base stations 310.

In response to a security alert message, each mobile wireless device 312 may operate as follows. The mobile wireless device 312 processes the security alert message. The security alert message may be a unique bit sequence indicating a national security situation. The mobile wireless device 312 is pre-programmed to alert the subscriber when it receives the security alert message. The mobile wireless device 312 may alert the subscriber through a special series of rings, beeps, or tones that get the attention of the subscriber. The mobile wireless device 312 may also alert the subscriber visually, such as illuminating a light or displaying a flashing message. The alert is unique to national security issues to ensure that the subscriber pays attention when the alert is provided.

When the mobile wireless device 312 has the attention of the subscriber, the mobile wireless device 312 may provide the subscriber with more information on the national security situation. The mobile wireless device 312 may display national security information, a color-coded message, or some other data. The mobile wireless device 312 may also display a phone number that the subscriber can call to get more information on the national security situation.

In an alternative embodiment, the MSCs 308 may broadcast the security alert messages to all mobile wireless devices 312 in their service area. The MSCs 308 may broadcast the messages through base stations 310 over a signaling and control channel. In communicating with mobile wireless devices 312, base station 310 may have multiple channels for calls and one or more channels for signaling and control information. One example of a signaling and control channel is a Broadcast Channel (BCCH). The signaling and control channel is reserved for signaling and control messages and most likely does not have a lot of bandwidth. Because of the small bandwidth, the security alert messages may have to be small (20 bits or less) and may not be able to carry much information.

We claim:

1. A wireless communication network, comprising:
a plurality of network nodes each operable to serve mobile wireless devices; and
a control system operable to receive national security information for a geographic region, to identify the network nodes serving the geographic region, and to transmit the national security information to the identified network nodes;
wherein each of the identified network nodes are operable to receive the national security information, to generate security alert messages based on the national security information, and to transmit the security alert messages to a plurality of mobile wireless devices served by that identified network node.

2. The wireless communication network of claim 1 wherein the security alert messages indicate a terrorist threat for the geographic region.

3. The wireless communication network of claim 1 wherein the security alert messages indicate a particular terrorist attack having taken place in the geographic region.

4. The wireless communication network of claim 1 wherein the security alert messages indicate a change in status of the Color-coded Threat Level System of the Department of Homeland Security.

5. The wireless communication network of claim 4 wherein the security alert messages comprise color-coded messages indicating the current status of the Color-coded Threat Level System.

6. The wireless communication network of claim 1 wherein the security alert messages comprise voice messages.

7. The wireless communication network of claim 1 wherein the security alert messages comprise text messages.

8. The wireless communication network of claim 1 wherein each of the network nodes is further operable to determine which subscribers currently served by that network node subscribe to a national security alerting service, and to transmit the security alert messages to the subscribers of the national security alerting service.

9. The wireless communication network of claim 1 wherein each of the network nodes is further operable to broadcast the security alert messages over a control channel reserved for control messages.

10. The wireless communication network of claim 1 wherein the mobile wireless devices comprise cell phones.

11. A method of alerting subscribers of a wireless communication network of national security situations, the method comprising:
receiving national security information for a geographic region;
identifying network nodes of the wireless communication network serving the geographic region;
transmitting the national security information to the identified network nodes;
generating security alert messages in each of the identified network nodes based on the national security information; and
transmitting the security alert messages from the identified network nodes to a plurality of mobile wireless devices served by the identified network nodes.

12. The method of claim 11 wherein the security alert messages indicate a terrorist threat for the geographic region.

13. The method of claim 11 wherein the security alert messages indicate a particular terrorist attack having taken place in the geographic region.

14. The method of claim 11 wherein the security alert messages indicate a change in status of the Color-coded Threat Level System of the Department of Homeland Security.

15. The method of claim 14 wherein the security alert messages comprise color-coded messages indicating the current status of the Color-coded Threat Level System.

16. The method of claim 11 wherein the security alert messages comprise voice messages.

17. The method of claim 11 wherein the security alert messages comprise text messages.

18. The method of claim 11 further comprising:
determining in each of the identified network nodes which subscribers currently served by that network node subscribe to a national security alerting service; and
transmitting the security alert messages from the identified network nodes to the subscribers of the national security alerting service.

19. The method of claim 11 further comprising:
broadcasting the security alert messages from the identified network nodes over a control channel reserved for control messages.

20. The method of claim 11 wherein the mobile wireless devices comprise cell phones.
